(19) United States
(12) Patent Application Publication
(10) Pub. No.: US 2026/0111359 A1
(43) Pub. Date: Apr. 23, 2026

(54) METHOD AND APPARATUS FOR CLEANING UP RESOURCES, AND DEVICE

(71) Applicant: Beijing Zitiao Network Technology Co., Ltd., Beijing (CN)

(72) Inventors: Hai HE, Beijing (CN); Rongrong ZHU, Beijing (CN)

(21) Appl. No.: 19/364,011

(22) Filed: Oct. 21, 2025

(30) Foreign Application Priority Data
Oct. 21, 2024 (CN) 202411472712.3

(51) Int. Cl. G06F 12/02

(52) U.S. Cl. CPC G06F 12/0253; G06F 2212/7205

(57) ABSTRACT

The present disclosure provides a method and apparatus for cleaning up resources, a computing device, a computer-readable storage medium, and a computer program product. The method includes: when a user edits a draft, saving information of at least one object of the draft in a first set and saving a weak reference to the at least one object in a second set, where each object is linked to a corresponding resource and is reclaimable; determining an object of a resource unused in the draft by comparing the first set with the second set; and cleaning up the resource corresponding to the unused object.

### CROSS-REFERENCE TO RELATED APPLICATION(S)

This application claims priority to Chinese Application No. 202411472712.3 filed Oct. 21, 2024, the disclosure of which is incorporated herein by reference in its entirety.

### FIELD

The present disclosure relates to the field of computer technologies, and more particularly, to a method and apparatus for cleaning up resources, a computing device, a computer-readable storage medium, and a computer program product.

### BACKGROUND

When a user uses an application of an electronic device for video creation, the user often needs to use a draft function. The draft function allows the user to save current progress when video editing is not completed, so as to continue subsequent editing or refinement. This is particularly convenient for users who need to complete video production in separate time periods or wish to modify and optimize videos many times in different time periods.

A draft includes a variety of creative materials or resources, such as videos, music, stickers, and effects.

### SUMMARY

In view of this, the present disclosure provides a method and apparatus for cleaning up resources, a computing device, a computer-readable storage medium, and a computer program product.

According to a first aspect of the present disclosure, a method for cleaning up resources is provided, including: when a user edits a draft, saving information of at least one object of the draft in a first set and saving a weak reference to the at least one object in a second set, where each object is linked to a corresponding resource and is reclaimable; determining an object of a resource unused in the draft by comparing the first set with the second set; and cleaning up the resource corresponding to the unused object.

According to a second aspect of the present disclosure, an apparatus for cleaning up resources is provided, including: a set determination unit configured to, when a user edits a draft, save information of at least one object of the draft in a first set and save a weak reference to the at least one object in a second set, where each object is linked to a corresponding resource and is reclaimable; an unused-resource determination unit configured to determine an object of a resource unused in the draft by comparing the first set with the second set; and a resource cleanup unit configured to clean up the resource corresponding to the unused object.

According to a third aspect of the present disclosure, a computing device is provided, including: at least one processing unit; and at least one memory, where the at least one memory is coupled to the at least one processing unit, and has stored thereon instructions executable by the at least one processing unit, and the instructions, when executed by the at least one processing unit, cause the computing device to perform the method according to the first aspect of the present disclosure.

According to a fourth aspect of the present disclosure, a non-transitory computer storage medium is provided, including machine-executable instructions that, when executed by a device, cause the device to perform the method according to the first aspect of the present disclosure.

According to a fifth aspect of the present disclosure, a computer program product is provided, including machine-executable instructions that, when executed by a device, cause the device to perform the method according to the first aspect of the present disclosure.

It should be understood that the content described in the summary is neither intended to identify key or essential features of embodiments of the present disclosure, nor is it intended to limit the scope of the present disclosure. Other features of the present disclosure will be readily understood from the following description.

### BRIEF DESCRIPTION OF THE DRAWINGS

The above and other objectives, features, and advantages of embodiments of the present disclosure will be easier to understand with reference to the following detailed descriptions of the accompanying drawings. In the accompanying drawings, a plurality of embodiments of the present disclosure will be described in an exemplary and non-limiting manner, in which:

FIG. 1 is a schematic diagram of an example environment in which an embodiment of the present disclosure can be implemented;

FIG. 2 is a schematic diagram of a creation application according to an embodiment of the present disclosure;

FIG. 3 is a flowchart of a method for cleaning up resources according to an embodiment of the present disclosure;

FIG. 4 is a schematic diagram of a flow of cleaning up resources according to an embodiment of the present disclosure;

FIG. 5 is a schematic diagram of a first set and a second set changing with time according to an embodiment of the present disclosure;

FIG. 6 is a block diagram of an apparatus for cleaning up resources according to an embodiment of the present disclosure; and

FIG. 7 is a block diagram of an electronic device according to an embodiment of the present disclosure.

Throughout the accompanying drawings, the same or similar reference numerals denote the same or similar elements.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, and the like may refer to different objects or the same object, unless otherwise explicitly defined. Other explicit and implicit definitions may also be included below.

In the process of using a draft for creation, a user often tries many different creative materials, but only retains a few that are applied to a video/picture when saving the draft. A draft editing page typically has a function to discard the current editing. For example, a draft originally has a custom sticker, but the user no longer wants to use the custom sticker effect. If a resource of the custom sticker is deleted only because the resource is no longer used in the draft, the user may choose to discard the current editing when quitting the editing, so that the draft reverts to a version it was at the time of just entering the editing page. At this point, the draft references the resource of the custom sticker. However, when the user subsequently reopens the draft, the sticker effect is lost because the resource has been deleted. Therefore, current creation applications typically follows an “add-only, no-deletion” principle for draft resources. However, this principle results in large disk cache space consumption by drafts, adversely affecting user experience. As the user continuously performs video creation, the resources used also increase. Excessive resources not only occupy the storage space of the device, but may also lead to performance degradation of the device. Therefore, it is necessary to manage the resources used during video creation and appropriately clean up some resources to maintain lower storage space occupancy of the application and ensure device performance.

To address or alleviate the aforementioned problem and/or other potential problems, an embodiment of the present disclosure provides a method for cleaning up resources. According to this method, throughout the creation process, two sets are maintained: one of the sets records all created resources, and the other set saves resources being used by the current draft model. By comparing the two sets, unused resources can be determined, enabling identification of which resources are referenced by the draft and automatic cleanup of unused resources when the draft needs to be saved, thereby reducing the size of the entire draft and saving a storage space for resources.

Basic principles and implementations of the present disclosure are illustrated below with reference to the accompanying drawings. It should be understood that exemplary embodiments are given only to enable those skilled in the art to better understand and thus implement the embodiments of the present disclosure, and are not intended to limit the scope of the present disclosure in any manner.

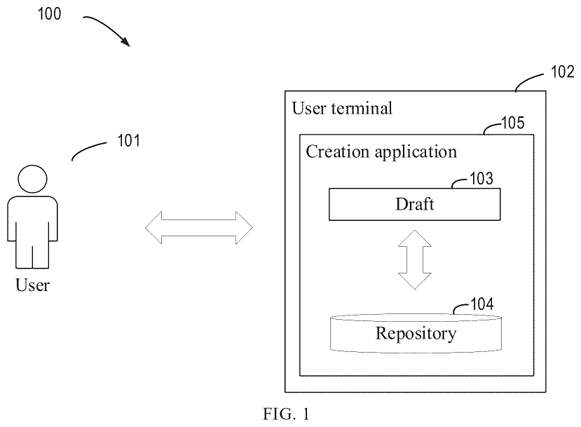

FIG. 1 is a schematic diagram of an environment 100 in which a plurality of embodiments of the present disclosure can be implemented. As shown in FIG. 1, the environment 100 includes a user 101 and a user terminal 102. Optionally, the user terminal 102 may specifically be a smartphone, a tablet, a portable computer, a smart television, an in-vehicle computer, a wearable device (e.g., a smart bracelet or a smartwatch), or the like that has a display function. A creation application 105 may be installed on the user terminal 102. The user 101 may use the creation application 105 to edit audio and a video, for example by adding music, an image effect, and the like for creation. In some implementations, in addition to running the creation application 105, the user terminal 102 may further implement a function related to the creation application 105 through an applet, a web page, or the like, so that the user 101 can perform creation on different platforms.

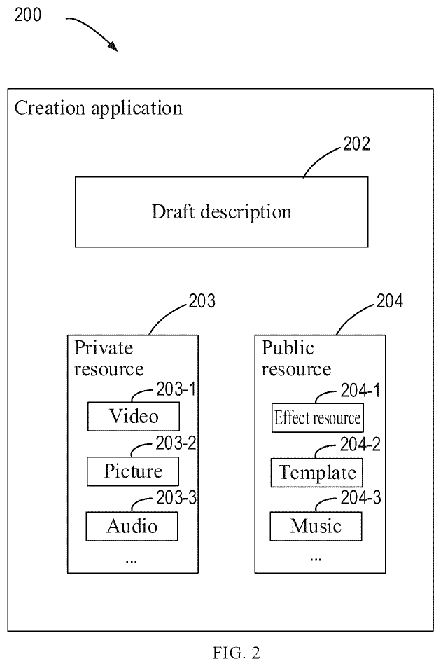

As shown in FIG. 1, the video creation application 105 of the user terminal 102 may include a draft 103 and a repository 104. The user 101 may upload a resource to be edited (e.g., a video/picture) to the repository 104 based on the video creation application 105, and edit the video/picture by using the draft 103 by invoking material resources (such as, a sticker and an effect) stored in the repository 104. In some embodiments, the repository 104 may alternatively be deployed in a network server, and the user 101 may download and invoke material resources in the repository 104 in the network server over a network. A location where the repository 104 is deployed is not limited in the present disclosure. As mentioned above, if the “add-only, no-deletion” principle is adopted for all resources used in the draft 103, large disk storage space consumption may be caused by the creation application, or even the device performance is adversely affected. The structure of the creation application is described in detail below with reference to FIG. 2.

FIG. 2 is a schematic diagram of a creation application 200 according to an embodiment of the present disclosure. The application shown in FIG. 2 may be an exemplary implementation of the creation application 105 of FIG. 1.

In some embodiments, the creation application 105 may include a draft description 202, a private resource 203, and a public resource 204. The draft description 202 may indicate a data model (such as a music model or a sticker model) used by the draft 103. The draft description 202 includes a unique identifier (id) representing the draft and information of a resource used by the draft. The resource may be a private resource or a public resource. The draft description 202 may record address information indicating an actual storage location of the resource, such as a local directory or a network address. Here, the private resource refers to a resource that is unique to a draft, and the public resource refers to a resource that is shared by multiple drafts.

When a user is editing a draft, each resource in the draft is assigned a corresponding object. The object includes an attribute of the resource (e.g., address information) and an associated method, to implement management and operations for the resource. According to a garbage collection mechanism, if there is no reference (except a weak reference) to an object in a memory, the object may be reclaimed.

In some embodiments, the private resource 203 may include a video 203-1, a picture 203-2, audio 203-3, and the like. In some implementations, the private resource 203 may be stored to the local repository 104, and once the private resource is lost or deleted, the draft 103 containing the lost private resource 203 is not recoverable.

In some embodiments, the public resource 204 may be stored in the local repository 104 or deployed in the repository 104 on the network server. If the local public resource 204 is lost or deleted, the user 101 may access, during recovery of the draft 103, the repository 104 over the network to download the lost public resource 204. The public resource 204 may include an effect resource 204-1, a template 204-2, music 204-3, and the like. During draft editing, the redundant private resource 203 and the redundant public resource 204 that are stored in the user terminal 102 may result in a large disk cache occupation. This requires identification and cleanup of unused resources therein.

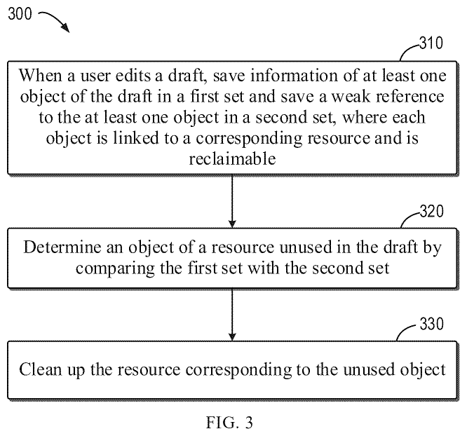

The process of cleaning up resources is further described below with reference to FIG. 3. FIG. 3 is a schematic flowchart of a method 300 for cleaning up resources according to some embodiments of the present disclosure. In some embodiments, the method 300 may be implemented by, for example, the user terminal 102 shown in FIG. 1. It should be understood that the method 300 may further include additional actions not shown and/or may omit actions shown, and the scope of the present disclosure is not limited in this regard.

As shown in FIG. 3, at a block 310, the method 300 may include: when a user edits a draft, saving information of at least one object of the draft in a first set and saving a weak reference to the at least one object in a second set, where each object is linked to a corresponding resource and is reclaimable. In some embodiments, the resource corresponding to the at least one object may be the private resource 203 shown in FIG. 2. Whenever the user tries, in the draft, to apply a different material resource to a video/picture, information related to the material resource is added to the first set. Optionally, the information related to the material resource may be address information. For example, in response to the resource of the at least one object being added to the draft, a path of the at least one object is recorded in the first set. That is to say, the first set records address information of the resource used in the creation process.

In some embodiments, the second set may include a data structure based on a weak reference. The weak reference is a reference relationship that does not prevent garbage collection. If an object is only referenced by a weak reference, the object is considered inaccessible (or weakly accessible) and may be reclaimed by a garbage collector at any time. Whenever the user adds the resource of at least one object to the draft, the at least one object is added to the data structure based on the weak reference (i.e., the second set).

When the user terminal triggers the garbage collection mechanism, if there is an object in the at least one object that has a corresponding resource not referenced by the draft, due to the weak reference relationship, the garbage collection mechanism ignores the weak reference to these objects in the second set, and destroys these objects in the second set. The garbage collection mechanism may be triggered, based on a memory management mechanism, either periodically or automatically when certain conditions are met.

At a block 320, the method 300 may include: determining an object of a resource unused in the draft by comparing the first set with the second set. Some objects in the second set are destroyed as the objects are not referenced by the saved draft, the number of resource objects recorded in the second set is less than the number of resource objects recorded in the first set. In some embodiments, the comparison between the first set and the second set may be performed after it is determined that the draft is saved. In some embodiments, a destroyed object in the second set may be determined first, and then based on information (e.g., address information) corresponding to the destroyed object in the first set, it is determined that a resource object in a difference set of the first set and the second set is an object of a resource unused in the draft. In other words, the object of the resource unused in the draft refers to an object that has address information in the first set and that has been recorded as destroyed in the second set.

At a block 330, the method 300 may include: cleaning up the resource corresponding to the unused object. After the object of the resource unused by the draft is determined, for example, by invoking a cleanup function, a resource object that has address information in the first set may be extracted and the remaining resource objects may be released. In some embodiments, after the resource corresponding to the unused object is cleaned up, the first set and the second set may be reset, to determine a redundant resource when the user edits the draft next time.

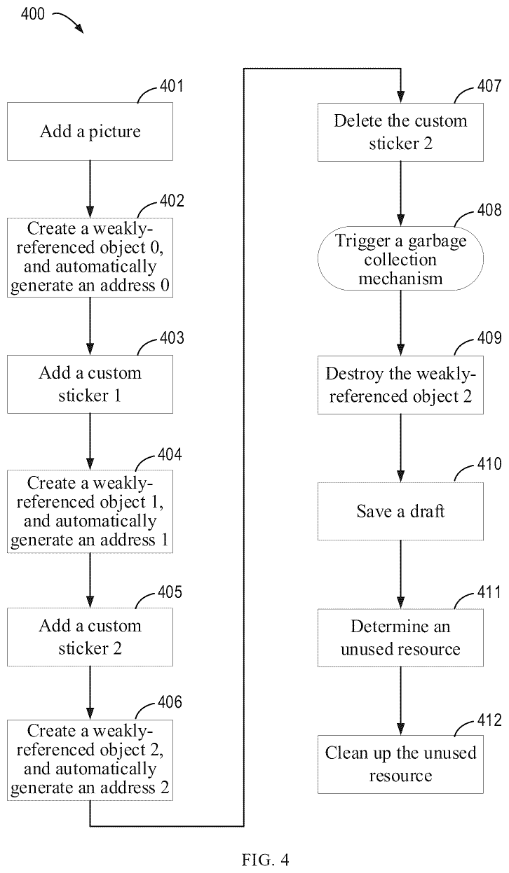

FIG. 4 is a schematic diagram of a flow of cleaning up resources according to an embodiment of the present disclosure. As shown in FIG. 4, in step 401, the user may add a picture in the creation application, to edit the picture by using a draft function in the creation application. As mentioned above, the picture may be considered as a private resource and stored in a root directory of the draft. In step 402, in response to the picture being added to the draft, the user terminal may automatically generate a path of the picture (which may be referred to as an address 0) and add the path to the first set, and create a weakly-referenced object 0 of the picture and add the weakly-referenced object to the second set.

In step 403, the user may use the draft function to add a material resource, such as a custom sticker 1, to the picture. In step 404, in response to the custom sticker 1 being applied to the picture editing, the user terminal may automatically generate a path of the custom sticker 1 (which may be referred to as an address 1) and add the path to the first set, and create a weakly-referenced object 1 of the custom sticker 1 and add the weakly-referenced object to the second set. At this point, the first set has stored thereon the addresses of the picture and the custom sticker 1, and the second set has stored thereon the weakly-referenced objects of the picture and the custom sticker 1.

In step 405, the user may continue to add a material resource, such as a custom sticker 2, to the picture. In step 406, in response to the custom sticker 2 being applied to the picture editing, the user terminal may automatically generate a path of the custom sticker 2 (which may be referred to as an address 2) and add the path to the first set, and create a weakly-referenced object 2 of the custom sticker 2 and add the weakly-referenced object to the second set. At this point, the first set has stored thereon the address 0 to the address 2, and the second set has stored thereon the weakly-referenced object 0 to the weakly-referenced object 2.

In step 407, the user may delete an unneeded material resource, such as the custom sticker 2, during the draft editing. Because of the weak reference relationship to the custom sticker 2 by the second set, the deletion of the custom sticker 2 is not affected. However, the custom sticker 2 is only deleted from the draft, and still occupies a certain space in a disk cache. In step 408, the user terminal triggers a garbage collection mechanism at a time, to detect whether an object in the memory has become garbage, such as an object with no reference. In step 409, since the custom sticker 2 referenced by the weakly-referenced object 2 in the second set has been deleted, the weakly-referenced object 2 is an object with no reference and is destroyed from the second set.

In step 410, after the user has finished editing the picture, the user may choose to save the draft, and at this point, all resources and valid resources that the user has used are stored in the first set and the second set, respectively. In step 411, the user terminal may calculate a difference set of unused resources based on the addresses of the resources saved in the first set and the weakly-referenced objects of the resources saved in the second set. For example, based on the address 0 to the address 2 in the first set and the weakly-referenced object 0 to the weakly-referenced object 1 in the second set, it can be calculated that an unused resource is the custom sticker 2. Then, in step 412, the user terminal may invoke a memory resource release function to clean up the unused resource to reduce the size of the entire draft, thereby enhancing the user experience.

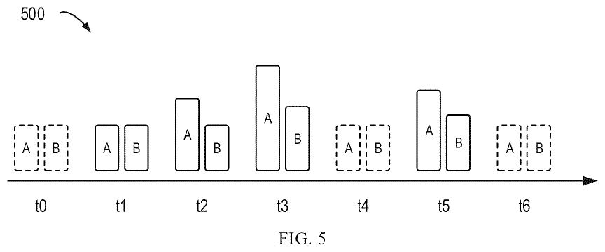

FIG. 5 is a schematic diagram 500 of a first set and a second set changing with time according to an embodiment of the present disclosure. As shown in FIG. 5, A is used to represent the first set, and B is used to represent the second set. At a time t0, a system is in an initial state and a user has not used a draft to add material resources for content creation. At this point, the first set and the second set are both empty sets. At a time t1, the user tries several material resources in the draft and does not delete any material resource before the draft is saved. At this point, all resources are recorded in both the first set and the second set. Therefore, the number of objects in the first set and the number of objects in the second set are the same.

At a time t2, the user tries several new material resources and deletes several undesired material resources from the draft. At this point, all resources are recorded in the first set, and the second set contains only valid resources. Therefore, the number of objects in the first set is greater than the number of objects in the second set. At a time t3, the user continues to try several new material resources and deletes several undesired material resources from the draft again. At this point, both the number of objects in the first set and the number of objects in the second set increase. However, all resources are still recorded in the first set, while only valid resources are still contained in the second set. Therefore, the number of objects in the first set is still greater than the number of objects in the second set.

At a time t4, the user chooses to save the edited draft. At this point, the user terminal first determines an unused resource based on the first set and the second set, and then invokes an invalid resource clearing capability to clear the unused resource. After the invalid resource is cleared, the user terminal sets both the first set and the second set to empty sets, for redundant resource determination when the user edits the draft next time.

At a time t5, the user re-edits the draft and tries several material resources, and then deletes several undesired material resources from the draft. The first set and the second set that are empty sets have stored thereon all resources and invalid resources, respectively. At a time t6, the user chooses to save the edited draft. At this point, the user terminal first determines an unused resource based on the first set and the second set, and then invokes the invalid resource clearing capability again to clear the unused resource. After the invalid resource is cleared, the user terminal sets both the first set and the second set to empty sets again, for invalid resource determination next time.

The exemplary embodiments of the present disclosure are described above with reference to FIG. 1 to FIG. 5. Compared with an existing solution for cleaning up resources, in the solution of cleaning up resources of the present disclosure, when a draft needs to be saved, specific resources referenced by the draft are perceived, and an unused resource is automatically cleaned up, thereby reducing the size of the entire draft.

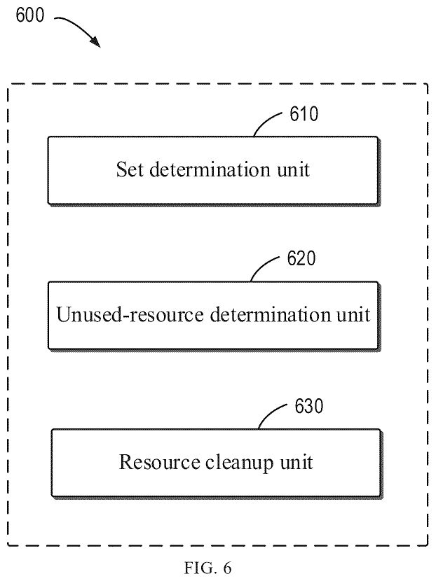

FIG. 6 is a schematic block diagram of an apparatus 600 for cleaning up resources according to an embodiment of the present disclosure. As shown in FIG. 6, the apparatus 600 includes a set determination unit 610, an unused-resource determination unit 620, and a resource cleanup unit 630. In some embodiments, the set determination unit 610 is configured to, when a user edits a draft, save information of at least one object of the draft in a first set and save a weak reference to the at least one object in a second set, where each object is linked to a corresponding resource and is reclaimable. The unused-resource determination unit 620 is configured to determine an object of a resource unused in the draft by comparing the first set with the second set. The resource cleanup unit 630 is configured to clean up the resource corresponding to the unused object.

It should be noted that more actions or steps shown with reference to FIG. 1 to FIG. 5 may be implemented by the apparatus 600 shown in FIG. 6. For example, the apparatus 600 may include more modules or units to implement the actions or steps described above, or some units or modules shown in FIG. 6 may be further configured to implement the actions or steps described above. Repeated descriptions are not provided herein.

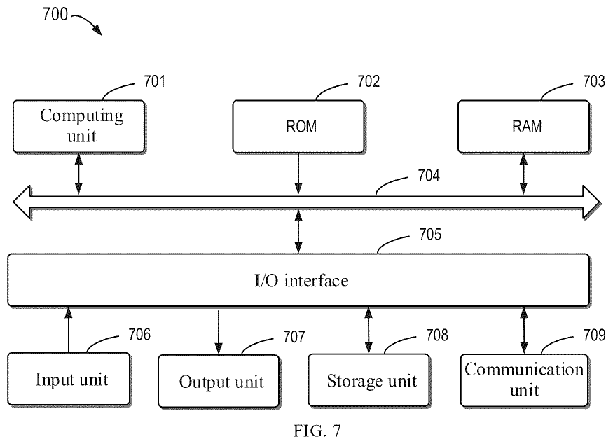

FIG. 7 is a schematic block diagram of an example device 700 that may be used to implement the embodiments of the present disclosure. As shown in the figure, the device 700 includes a computing unit 701 that may perform a variety of appropriate actions and processing in accordance with computer program instructions stored in a read-only memory (ROM) 702 or computer program instructions loaded from a storage unit 708 into a random-access memory (RAM) 703. The RAM 703 may further store various programs and data required for the operation of the device 700. The computing unit 701, the ROM 702, and the RAM 703 are connected to each other by a bus 704. An input/output (I/O) interface 705 is also connected to the bus 704.

A plurality of components in the device 700 are connected to the I/O interface 705, including: an input unit 706, such as a keyboard or a mouse; an output unit 707, such as various types of displays or speakers; the storage unit 708, such as a magnetic disk or an optical disk; and a communication unit 709, such as a network card, a modem, or a wireless communication transceiver. The communication unit 709 allows the device 700 to exchange information/data with other devices over a computer network such as the Internet and/or various telecommunication networks.

The computing unit 701 may be various general-purpose and/or special-purpose processing components with processing and computing capabilities. Some examples of the computing unit 701 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and the like. The computing unit 701 performs various methods and processing described above, such as the method 300. For example, in some embodiments, the method 300 may be implemented as a computer software program tangibly embodied in a machine-readable medium, such as the storage unit 708. In some embodiments, some or all of the computer programs may be loaded into and/or installed onto the device 700 via the ROM 702 and/or the communication unit 709. When the computer program is loaded onto the RAM 703 and executed by the computing unit 701, one or more steps of the method 300 described above can be performed. Alternatively, in other embodiments, the computing unit 701 may be configured, in any other appropriate manner (for example, by means of firmware), to perform the method 300.

In some embodiments, the methods and processes described above may be implemented as a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random-access memory (RAM), a read-only memory (ROM), an erasable programmable read-only memory (EPROM) (or a flash memory), a static random-access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used herein is not to be interpreted as a transient signal, such as a radio wave or another freely propagating electromagnetic wave, an electromagnetic wave propagating through a waveguide or another transmission medium (e.g., an optical pulse through a fiber-optic cable), or an electrical signal transmitted over a wire.

The computer-readable program instructions described herein may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (for example, connected over the Internet by using an Internet service provider). In some embodiments, an electronic circuit, such as a programmable logic circuit, a field programmable gate array (FPGA), or a programmable logic array (PLA), is personalized by using state information of the computer-readable program instructions. The electronic circuit may execute the computer-readable program instructions to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or the other programmable data processing apparatus, create an apparatus for implementing functions/actions specified in one or more blocks in the flowchart and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowchart and/or the block diagrams.

The flowcharts and the block diagrams in the accompanying drawings illustrate possible system architectures, functions, and operations of the device, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions marked in the blocks may occur in a sequence different from that marked in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

Various embodiments of the present disclosure have been described above. The foregoing descriptions are exemplary, not exhaustive, and are not limited to the disclosed embodiments. Many modifications and variations are apparent to those of ordinary skill in the art without departing from the scope and spirit of the described embodiments. The terminology used herein is intended to best explain the principles, practical applications, or technical improvements in the market of the embodiments, or to enable others of ordinary skill in the art to understand the embodiments disclosed herein.

I/We claim:

1. A method for cleaning up resources, comprising:
in response to a user editing a draft, saving information of at least one object of the draft in a first set and saving a weak reference to the at least one object in a second set, wherein each object is linked to a corresponding resource and is reclaimable;
determining an object of a resource unused in the draft by comparing the first set with the second set; and
cleaning up the resource corresponding to the unused object.

2. The method according to claim 1, wherein the at least one object has address information, and saving the information of the at least one object of the draft in the first set comprises:
recording the address information of the at least one object in the first set in response to a resource of the at least one object being added to the draft.

3. The method according to claim 1, wherein the second set comprises a data structure based on the weak reference, and saving the weak reference to the at least one object in the second set comprises:
adding the at least one object to the data structure based on the weak reference in response to a resource of the at least one object being added to the draft.

4. The method according to claim 1, further comprising:
destroying, based on a garbage collection mechanism, an object of a resource not referenced by the draft among the at least one object.

5. The method according to claim 4, wherein the garbage collection mechanism ignores the weak reference to the at least one object in the second set.

6. The method according to claim 1, wherein determining the object of the resource unused in the draft comprises:
determining a destroyed object in the second set; and
determining the object of the resource unused in the draft based on information corresponding to the destroyed object in the first set.

7. The method according to claim 1, wherein determining the object of the resource unused in the draft comprises:
comparing, in response to determining that the draft is saved, the first set with the second set to determine the object of the resource unused in the draft.

8. The method according to claim 1, further comprising:
resetting the first set and the second set after cleaning up the resource corresponding to the unused object.

9. A computing device, comprising:
at least one processing unit; and
at least one memory, wherein the at least one memory is coupled to the at least one processing unit, and has stored thereon instructions executable by the at least one processing unit, and the instructions, when executed by the at least one processing unit, cause the computing device to:
in response to a user editing a draft, save information of at least one object of the draft in a first set and save a weak reference to the at least one object in a second set, wherein each object is linked to a corresponding resource and is reclaimable;
determine an object of a resource unused in the draft by comparing the first set with the second set; and
clean up the resource corresponding to the unused object.

10. The computing device according to claim 9, wherein the at least one object has address information, and the instructions to save the information of the at least one object of the draft in the first set comprise instructions to:
record the address information of the at least one object in the first set in response to a resource of the at least one object being added to the draft.

11. The computing device according to claim 9, wherein the second set comprises a data structure based on the weak reference, and the instructions to save the weak reference to the at least one object in the second set comprise instructions to:
add the at least one object to the data structure based on the weak reference in response to a resource of the at least one object being added to the draft.

12. The computing device according to claim 9, wherein the instructions further cause the computing device to:
destroy, based on a garbage collection mechanism, an object of a resource not referenced by the draft among the at least one object.

13. The computing device according to claim 12, wherein the garbage collection mechanism ignores the weak reference to the at least one object in the second set.

14. The computing device according to claim 9, wherein the instructions to determine the object of the resource unused in the draft comprise instructions to:
determine a destroyed object in the second set; and
determine the object of the resource unused in the draft based on information corresponding to the destroyed object in the first set.

15. The computing device according to claim 9, wherein the instructions to determine the object of the resource unused in the draft comprise instructions to:
compare, in response to determining that the draft is saved, the first set with the second set to determine the object of the resource unused in the draft.

16. The computing device according to claim 9, wherein the instructions further cause the computing device to:
reset the first set and the second set after cleaning up the resource corresponding to the unused object.

17. A non-transitory computer storage medium, comprising machine-executable instructions that, when executed by a device, cause the device to:
in response to a user editing a draft, save information of at least one object of the draft in a first set and save a weak reference to the at least one object in a second set, wherein each object is linked to a corresponding resource and is reclaimable;
determine an object of a resource unused in the draft by comparing the first set with the second set; and
clean up the resource corresponding to the unused object.

18. The non-transitory computer storage medium according to claim 17, wherein the at least one object has address information, and the instructions to save the information of the at least one object of the draft in the first set comprise instructions to:
record the address information of the at least one object in the first set in response to a resource of the at least one object being added to the draft.

19. The non-transitory computer storage medium according to claim 17, wherein the second set comprises a data structure based on the weak reference, and the instructions to save the weak reference to the at least one object in the second set comprise instructions to:
add the at least one object to the data structure based on the weak reference in response to a resource of the at least one object being added to the draft.

20. The non-transitory computer storage medium according to claim 17, wherein the instructions further cause the device to:
destroy, based on a garbage collection mechanism, an object of a resource not referenced by the draft among the at least one object.
